(19) United States
(12) Patent Application Publication
(10) Pub. No.: US 2009/0008179 A1
(43) Pub. Date: Jan. 8, 2009

(54) MOTORCYCLE HAVING A ROTATABLY-MOUNTED ENGINE

(76) Inventors: Erik Buell, Mukwonago, WI (US); Edward A. Weston, Cary, IL (US)

Correspondence Address: MICHAEL BEST & FRIEDRICH LLP, 100 E WISCONSIN AVENUE, Suite 3300, MILWAUKEE, WI, 53202, US

(21) Appl. No.: 11/772,455

(22) Filed: Jul. 2, 2007

(51) Int. Cl. B62M 7/00

(52) U.S. Cl. 180/229

(57) ABSTRACT

A motorcycle includes a frame including a first engine mount defining a first attachment axis, the frame further including a second engine mount spaced forwardly of the first engine mount. The motorcycle further includes an engine mounted to the frame at least by the first engine mount and the second engine mount, wherein the engine is configured to rotate relative to the frame about the first attachment axis when the engine is detached from the second engine mount. A radiator is mounted to the engine. The radiator is fluidly coupled to the engine for heat transfer, and the radiator is configured to rotate with the engine relative to the frame about the first attachment axis

### BACKGROUND

The present invention relates to a motorcycle having a particular mounting arrangement for mounting an engine of the motorcycle. More particularly, the invention relates to a motorcycle engine assembly configured to be moved between various orientations with respect to a frame of the motorcycle.

### SUMMARY

In one embodiment, the invention provides a motorcycle having a central axis extending longitudinally between a front wheel and a rear wheel of the motorcycle. The motorcycle includes a frame including a first engine mount defining a first attachment axis substantially perpendicular to the central axis, the frame further including a second engine mount spaced forwardly of the first engine mount. The motorcycle further includes an engine mounted to the frame at least by the first engine mount and the second engine mount. The engine is configured to rotate relative to the frame about the first attachment axis when the engine is detached from the second engine mount. A radiator is mounted to the engine. The radiator is fluidly coupled to the engine for heat transfer, and the radiator is configured to rotate with the engine relative to the frame about the first attachment axis.

In another embodiment, the invention provides a method of servicing a cylinder head of an engine of a motorcycle. The method includes providing a motorcycle frame, an engine, and a mounting arrangement therebetween. The engine is secured by the mounting arrangement in a mounted orientation relative to the frame. A portion of the mounting arrangement between the motorcycle frame and the engine is disconnected so that the engine is only partially supported by the mounting arrangement. The engine is rotated downward from the frame from the mounted orientation to a service orientation to increase the clearance between the cylinder head and the frame.

Other aspects of the invention will become apparent by consideration of the detailed description and accompanying drawings.

### BRIEF DESCRIPTION OF THE DRAWINGS

FIG. 1 is a side view of a motorcycle embodying the invention.

FIG. 2 is a partially exploded side view of the motorcycle of FIG. 1.

FIG. 3 is a left side detail view of a mounting arrangement between the engine and the frame of the motorcycle of FIG. 1.

FIG. 4 is a right side detail view of a mounting arrangement between the engine and the frame of the motorcycle of FIG. 1.

FIG. 5 is a bottom view of the frame of the motorcycle of FIG. 1.

FIG. 6 is a partial front view of the motorcycle of FIG. 1 with selected parts removed for clarity.

FIG. 7 is a side view of the motorcycle of FIG. 1 with the engine assembly rotated to a service orientation.

FIG. 8 is a side view of the motorcycle of FIG. 1 with the engine assembly rotated to a service orientation and a protective cover removed.

FIG. 9A is a first perspective view of the engine of the motorcycle of FIG. 1.

FIG. 9B is a second perspective view of the engine of the motorcycle of FIG. 1.

FIG. 10 is a first perspective view of another motorcycle embodying the invention.

FIG. 11 is a second perspective view of the motorcycle of FIG. 10.

FIG. 12 is a first side view of a portion of the motorcycle of FIG. 10 showing the engine assembly in a mounted orientation.

FIG. 13 is a second side view of a portion of the motorcycle of FIG. 10 showing the engine assembly in a service orientation.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

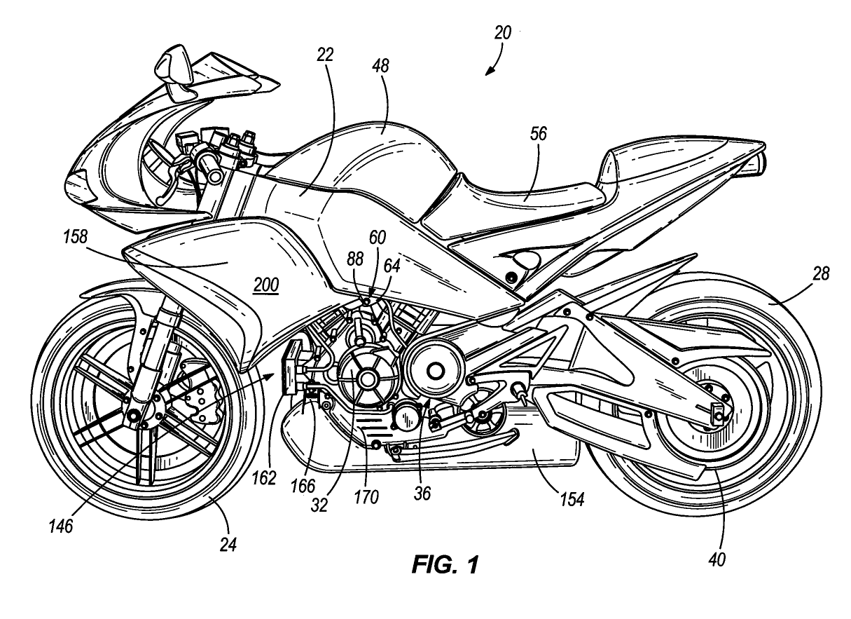

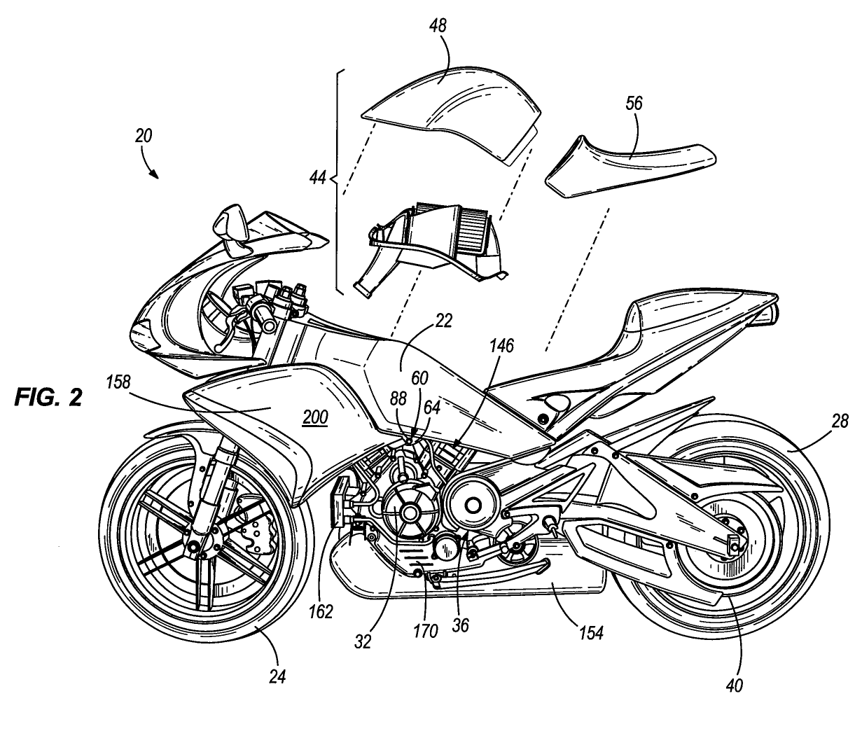

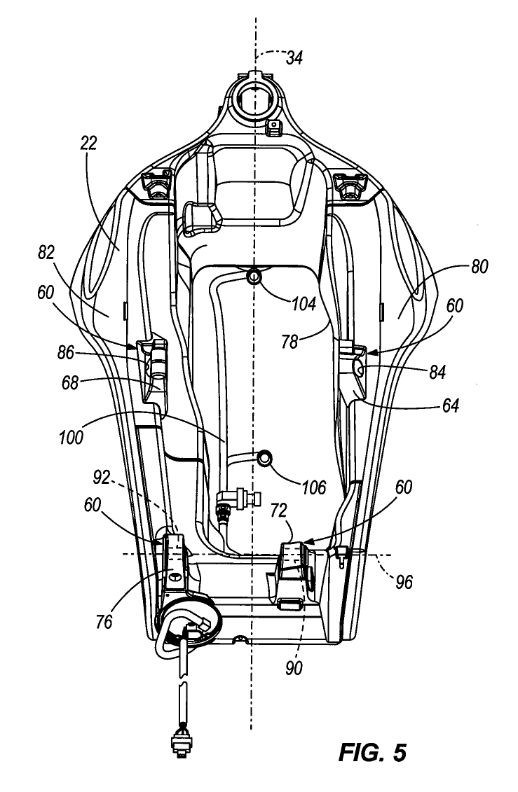

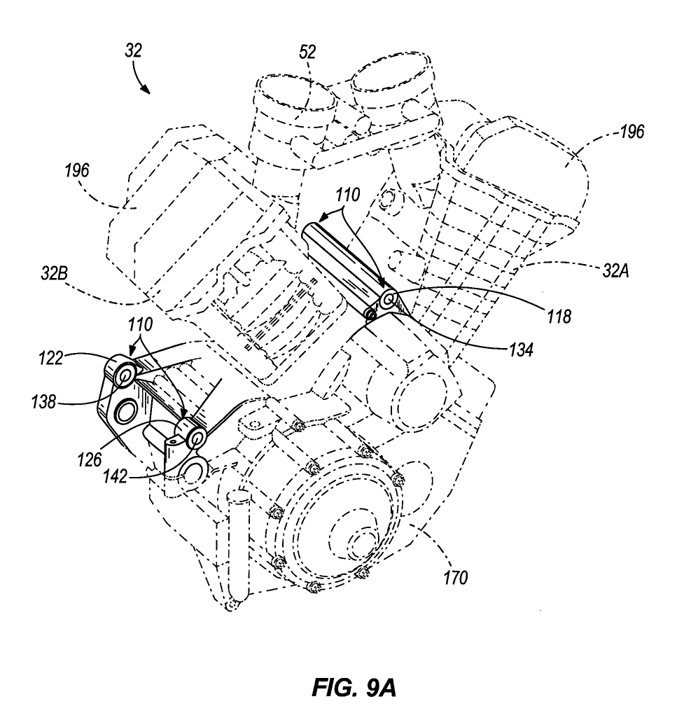

FIG. 1 illustrates a motorcycle 20 including a frame 22, a front wheel 24, a rear wheel 28, and an engine 32. A central axis 34 (FIG. 5) is defined along a longitudinal direction of the motorcycle 20 (i.e., along a common plane of the front wheel 24 and the rear wheel 28), passing through the center of the frame 22. The engine 32 provides power to drive the rear wheel 28 through a transmission 36 and an endless drive member, such as a belt 40. An airbox 44 (FIG. 2) including an airbox cover 48 is positioned above the engine 32. The airbox 44 is configured to filter and direct the intake air into the engine 32 for combustion. Intake air flows through the airbox 44 and is delivered to the engine 32 in metered quantity by a throttle assembly 52 (FIGS. 9A and 9B). In the illustrated embodiment, the throttle assembly 52 includes a pair of throttle valves, one for each of the cylinders 32A, 32B of the engine 32 (which is shown as a V-twin configuration). A seat 56 is provided on the motorcycle 20 to support a rider (not shown).

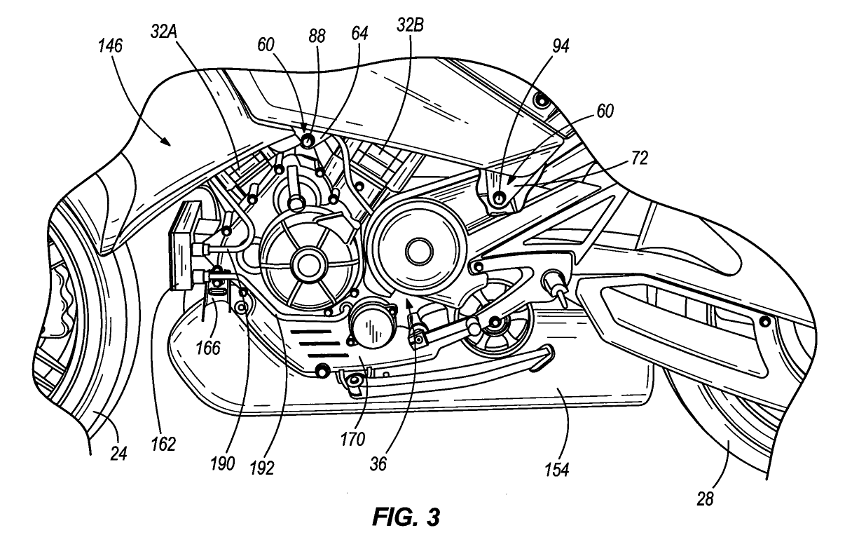

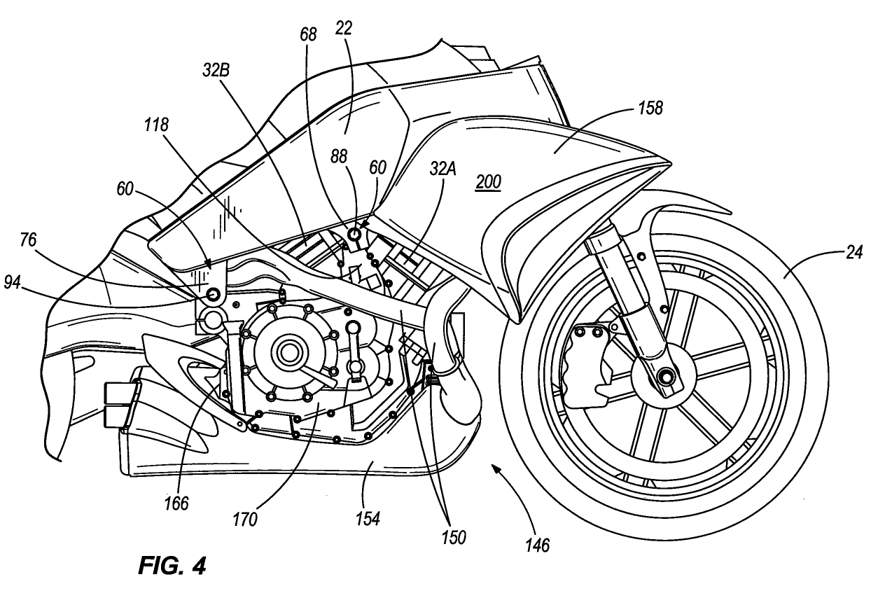

As shown in FIGS. 1-8, the frame 22 includes a plurality of mounting locations 60 for mounting the engine 32. In the illustrated embodiment, the mounting locations 60 are defined by a pair of forward engine mounts 64, 68 and a pair of rearward engine mounts 72, 76 (FIGS. 3-5). The forward and rearward engine mounts 64, 68, 72, 76 constitute part of a mounting arrangement between the frame 22 and the engine 32 (additional parts of the mounting arrangement being present on the engine 32 as described in further detail below). The frame 22 includes a central opening 78 (FIG. 5), which receives an upper portion of the engine 32, the airbox 44, and the throttle assembly 52.

The forward engine mounts 64, 68 protrude downwardly from respective side portions 80, 82 of the frame 22 and include respective openings 84, 86 (FIGS. 5, 7, 8) configured to receive fasteners 88. The rearward engine mounts 72, 76 also protrude downwardly from the respective side portions 80, 82 of the frame 22 and include respective openings 90, 92 (FIG. 5) configured to receive fasteners 94. The openings 90, 92 in the rearward engine mounts 72, 76 define a mounting axis 96 for attaching the engine 32 as described in further detail below. The forward engine mounts 64, 68 and the rearward engine mounts 72, 76 can be unitarily cast as a single piece with the frame 22. Alternatively, one or more of the forward and rearward engine mounts 64, 68, 72, 76 can be formed separately from the frame 22 and subsequently coupled thereto (e.g., by welding, threaded fasteners, bonding material, permanent or semi-permanent fasteners, etc.).

As shown in FIG. 5, the motorcycle 20 includes a fuel supply line 100 in fluid communication with a fuel reservoir (such as the frame 22, which is hollowed to form a fuel reservoir) and configured to supply liquid fuel to the engine 32. Specifically, the fuel supply line 100 includes a pair of couplings 104, 106 configured to attach to respective fuel injectors (not shown) of the engine 32. Thus, the fuel supply line is fluidly and mechanically coupled to the engine 32. The couplings 104, 106 of the fuel supply line 100 can be quick-connect couplings, which facilitate tool-free connection and disconnection.

FIGS. 9A and 9B illustrate the engine 32, which includes four mounting locations 110 corresponding to the four engine mounts 64, 68, 72, 76 of the frame 22. The mounting locations 110 include a pair of forward mounts 114, 118 positioned forward of the front cylinder 32A and a pair of rearward mounts 122, 126 positioned rearward of the front cylinder 32A. The forward and rearward mounts 114, 118, 122, 126 constitute part of the mounting arrangement between the frame 22 and the engine 32. The mounting arrangement further includes the fasteners 88, 94 associated with the engine mounts 64, 68, 72, 76 of the frame 22 and the mounts 114, 118, 122, 126 of the engine 32. As shown in the figures, the frame 22 does not include any frontal frame member (i.e., “down tube”) extending in front of the engine 32. Furthermore, the frame 22 does not include any lower frame member extending below or beneath the engine 32. Thus, the engine 32 is suspended from the frame 22. In some embodiments, the engine 32 is solely supported by the engine mounts 64, 68, 72, 76 on the frame 22.

The forward mount 114 (FIG. 9B) on the left side of the engine 32 corresponds to the forward engine mount 64 on the left side of the frame 22 (according to a mounted rider's left-hand side). The forward mount 114 includes an opening 130 configured to be aligned with the opening 84 of the forward engine mount 64 to receive the fastener 88. In some embodiments, the opening 84 in the forward engine mount 64 of the frame 22 is a through hole, and the opening 130 in the forward mount 114 of the engine 32 is threaded. The forward mount 118 (FIG. 9A) on the right side of the engine 32 corresponds to the forward engine mount 68 on the right side of the frame 22 (according to a mounted rider's right-hand side). The forward mount 118 includes an opening 134 configured to be aligned with the opening 86 of the forward engine mount 68 to receive the fastener 88. In some embodiments, the opening 86 in the forward engine mount 68 of the frame 22 is a through hole, and the opening 134 in the forward mount 118 of the engine 32 is threaded.

The rearward mount 122 on the left side of the engine 32 (FIG. 9B) includes an opening 138 and corresponds to the rearward engine mount 72 on the frame 22. The opening 138 in the rearward mount 122 is configured to be aligned with the opening 90 in the rearward engine mount 72 of the frame 22. The fastener 94 connects the mounts 72, 122. In some embodiments, the left side rearward engine mount 72 of the frame 22 lies laterally inward (closer to the central axis 34) of the left side rearward mount 122 of the engine 32. Thus, the opening 90 in the rearward engine mount 72 of the frame 22 is threaded, and the opening 138 in the rearward mount 122 of the engine 32 is a through hole.

The rearward mount 126 on the right side of the engine 32 (FIG. 9A) includes an opening 142 and corresponds to the rearward engine mount 76 on the frame 22. The opening 142 in the rearward mount 126 is configured to be aligned with the opening 92 in the rearward engine mount 76 of the frame 22. The fastener 94 connects the mounts 76, 126. In some embodiments, the right side rearward mount 126 of the engine 32 lies laterally inward (closer to the central axis 34) of the right side rearward engine mount 76 of the frame 22. Thus, the opening 92 in the rearward engine mount 76 of the frame 22 is a through hole, and the opening 142 in the rearward mount 126 of the engine 32 is threaded.

An engine assembly 146 (FIGS. 1-4, 7, 8) of the motorcycle 20 includes not only the engine 32, but also additional components directly associated with the operation of the engine (i.e., intake system, exhaust system, fuel system, cooling system, etc.). For example, the airbox 44, the throttle assembly 52, and the fuel supply line 100 are part of the engine assembly 146. The engine assembly 146 also includes a pair of headers 150, a muffler 154, liquid cooling components of a cooling system (including a pair of radiators 158 and an oil cooler 162), and an electrical system.

The headers 150 are coupled directly to the front and rear cylinders 32A, 32B of the engine 32 to receive exhaust gases therefrom. Exhaust gases are directed through the headers 150 to the muffler 154, and then through the muffler 154 to the atmosphere. The muffler 154 includes several brackets 166 for mounting the muffler 154 directly to the engine 32 (i.e., to a joint crankcase and transmission case 170 of the engine 32). Thus, the muffler 154 is fluidly and mechanically coupled to the engine 32. As described in further detail below, the muffler 154 (and the headers 150) may move with the engine 32 relative to the frame 22 so that the engine 32 may be moved, rotated, and/or re-oriented relative to the frame 22 without removal of the muffler 154, and without modification to the muffler 154.

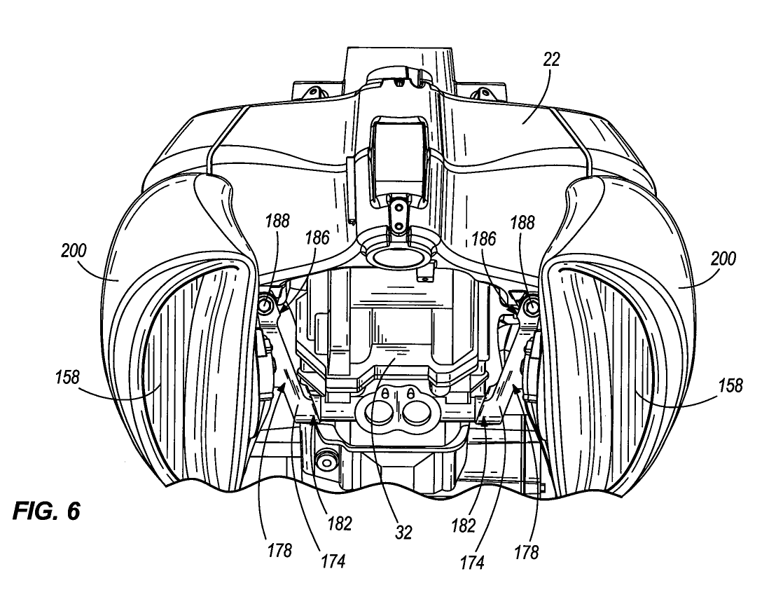

The radiators 158 are provided in fluid communication with cooling passages inside the engine 32 so that heat produced by the operation of the engine 32 may be transferred by a heat transfer fluid to the radiators 158 and from the radiators 158 to the atmosphere. The radiators 158 are mounted to the engine 32. Thus, the radiators 158 are fluidly and mechanically coupled to the engine 32. The radiators 158 are also mounted to the frame 22. As illustrated in FIG. 6, a mounting arrangement including a mounting bracket 174 is provided for each of the radiators 158. Each mounting bracket 174 has at least one mounting location 178 for coupling to the associated radiator 158, one mounting location 182 for coupling to the engine 32, and one mounting location 186 for coupling to the frame 22. Fasteners 188 are provided for attachment at each of the mounting locations 178, 182, 186. As described in further detail below, the radiators 158 may move with the engine 32 relative to the frame 22 so that the engine 32 may be moved, rotated, and/or re-oriented relative to the frame 22 without removal of the radiators 158, without modification to the radiators 158, and without breaking any “wet” connections of the radiators 158.

The oil cooler 162 is mounted on a front crankcase portion of the joint transmission case and crankcase 170 of the engine 32. The oil cooler 162 is in fluid communication with the engine 32 (specifically, an oil reservoir of the joint transmission case and crankcase 170) via an oil supply line 190 and an oil return line 192 (FIG. 3). Thus, the oil cooler 162 is fluidly and mechanically coupled to the engine 32. The oil cooler 162 is configured to transfer heat from the oil inside the engine 32 to the atmosphere. The oil cooler 162 and the supply and return lines 190, 192 are configured to move with the engine 32 relative to the frame 22 without removal of the oil cooler 162 and without disconnection of any “wet” connections (i.e., the supply and return lines 190, 192).

Although not illustrated, the electrical system may include several electrical connections between various components of the engine assembly 146 and the remainder of the motorcycle 20. Such electrical connections may be provided with detachable connectors so that the associated electrical wires do not restrain the movement of the engine assembly 146 relative to the frame 22 (and other portions of the motorcycle 20 that are relatively fixed with respect to the frame 22) and so that the electrical wires are not strained or broken by movement of the engine assembly 146 relative to the frame 22.

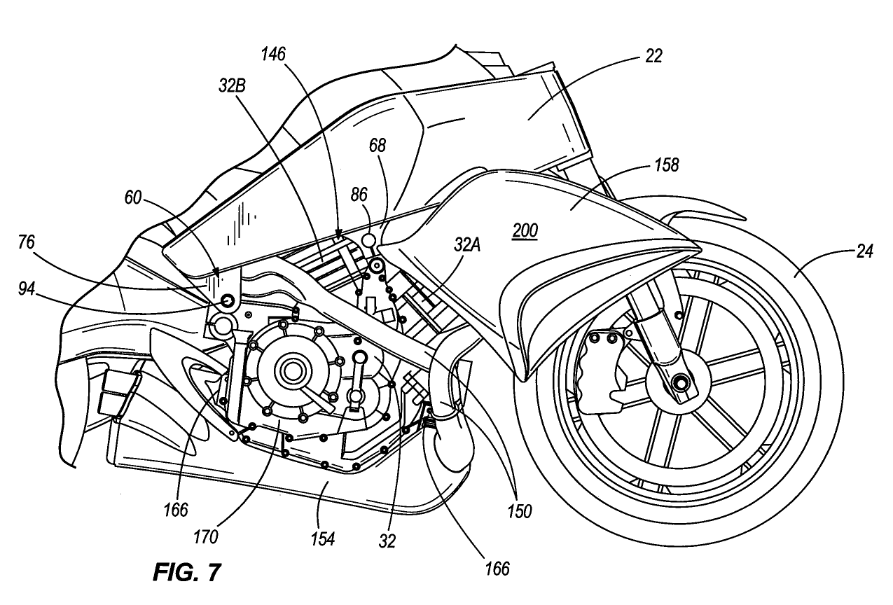

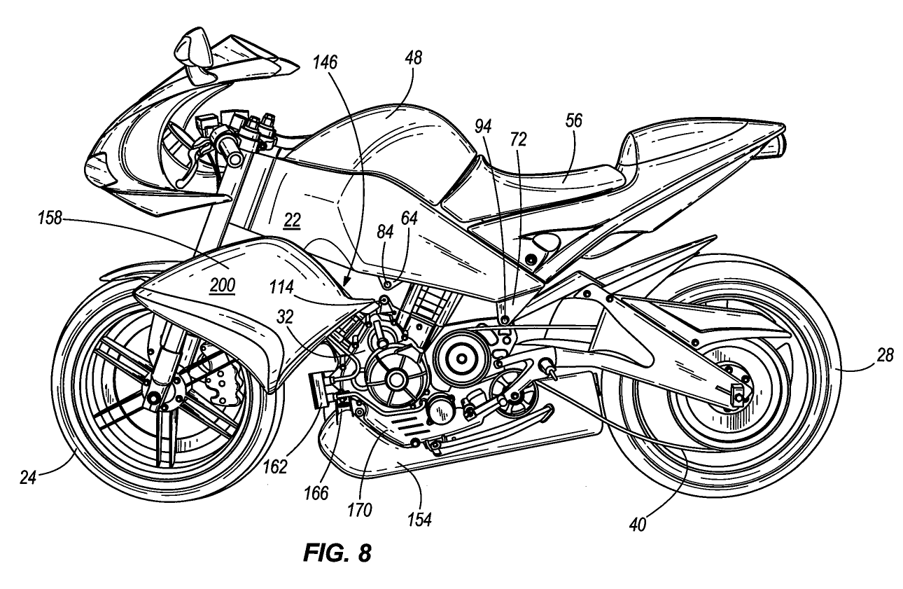

The mounting arrangement between the frame 22 and the engine 32 is configured to allow re-orientation of the engine 32 (and additional components of the engine assembly 146) relative to the frame 22. FIGS. 1-4 illustrate the engine 32 in a first configuration, or “mounted orientation”, and FIGS. 7 and 8 illustrate the engine 32 in a second configuration or “service orientation”. For clarity, the throttle assembly 52 is not shown in FIGS. 7 and 8. In the service orientation, clearance above the engine 32 is increased compared to the mounted orientation. The increased clearance provided by the service orientation may enable service on the engine 32 that is very difficult or impossible to accomplish in the mounted orientation. Exemplary engine servicing procedures may include, but are not limited to, removal of one or more valve covers 196 (FIGS. 9A and 9B) of the engine 32, and checking/adjusting valve clearances. In some embodiments, the service orientation positions the front cylinder 32A generally below the frame 22 while the rear cylinder 32B is positioned substantially in the opening 78 of the frame 22 so that it is accessible through the frame 22.

In order to re-orient the engine 32 from the mounted orientation (FIGS. 1-4) to the service orientation (FIGS. 7 and 8), the seat 56 (FIG. 2) is removed to gain access to the airbox 44, which is also removed. Thus, the air intake passage, of which the airbox 44 forms a portion, is detached from the throttle assembly 52, enabling the throttle assembly 52 to move with the engine 32 relative to the frame 22. Because the upper part of the engine 32 (including the throttle assembly 52) is rotated generally toward the front of the motorcycle 20 from the mounted orientation to the service orientation, throttle cables (e.g., from a handlebar throttle grip) do not require removal or adjustment. The bottom part of the engine 32 and the transmission 36 rotate slightly rearward when the engine 32 is moved from the mounted orientation to the service orientation. Therefore, the belt 40 does not require removal or adjustment of the associated final drive components.

The mounting brackets 174 that couple the radiators 158 to the frame 22 and to the engine 32 are detached from the frame 22 at the mounting locations 186 (e.g., by removal of associated threaded fasteners 188). Thus, the radiators 158 are free to move with the engine 32 relative to the frame 22. In some embodiments, additional fasteners (not shown) for mounting external radiator body panels 200 to the frame 22 are also removed before the radiators 158 are free to rotate with the engine 32 relative to the frame 22.

Electrical connectors may be disconnected so that the associated electrical wires do not hinder the movement of the engine 32 relative to the frame 22. In some embodiments, a main interface connector (chassis to engine harness), one or more fan connectors (for fans associated with the radiators 158), a stator connector, and a horn connector may all be disconnected.

The fasteners 88 associated with the forward engine mounts 64, 68 of the frame 22 and the forward mounts 114, 118 of the engine 32 are removed so that the engine 32 is supported by the frame 22 only at the mounting axis 96 (at the rearward engine mounts 72, 76 of the frame 22 and the rearward mounts 122, 126 of the engine 32). The fasteners 92 at the mounting axis 96 are loosened, but not removed, enabling the engine 32 to rotate substantially freely relative to the frame 22 about the mounting axis 96. Because the mounting axis 96 is substantially perpendicular to the central axis 34, the engine 32 moves substantially parallel to or along the central axis 34 when the engine 32 is detached from the forward engine mounts 64, 68 of the frame 22. Due to the relative location of the mounting axis 96 on the engine 32 of the illustrated embodiment, the bulk of the engine 32 moves generally forward and downward during rotation from the mounted orientation to the service orientation.

After engine service has been completed, or when desired, the engine 32 is rotated back to the mounted orientation, and the engine 32 is re-attached to the engine mounts 64, 68, 72, 76 of the frame 22. Likewise, the radiator mounting brackets 174 are re-attached to the mounting locations 186 on the frame 22, electrical connectors are re-connected, the airbox 44 and seat 56 are mounted back onto the motorcycle 20, and the fasteners 92 at the mounting axis 96 are re-tightened.

In some embodiments, rotation of the engine 32 about the mounting axis 96 of about 10 degrees is sufficient for creating an acceptable clearance to remove the valve covers 196, etc. However, the engine 32 may be rotated 15 degrees or more because many of the major components of the engine assembly 146 are fluidly and mechanically coupled directly to the engine 32 (including the muffler 154, the radiators 158, and the oil cooler 162). The fuel supply line 100 may be disconnected in some embodiments, but is not required to be disconnected for rotation of the engine 32 within about 10 degrees. Disconnection of the fuel supply line 100 may be desirable so that the fuel supply line 100 does not obstruct the engine service procedure.

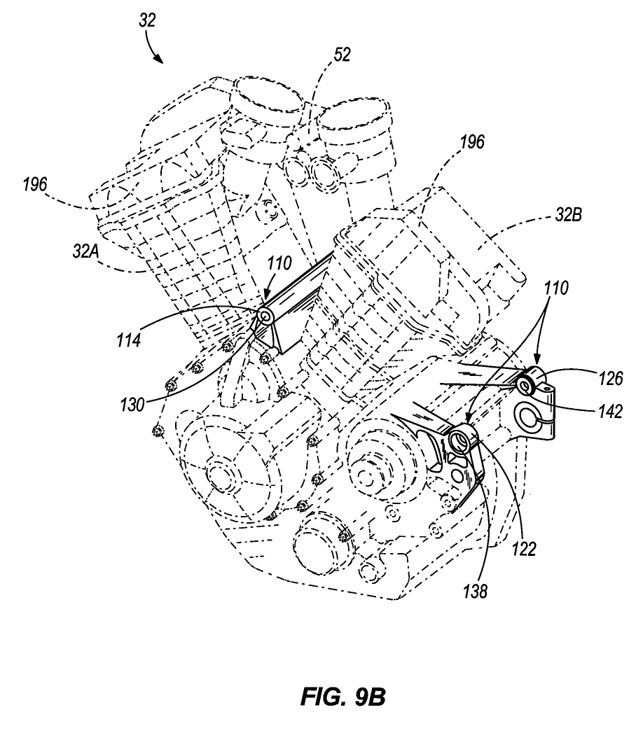

FIGS. 10-13 illustrate a motorcycle 220 of an off-road variety embodying the invention. The motorcycle 220 includes a frame 222, a front wheel 224, a rear wheel 228, and an engine 232. A central axis 234 is defined along a longitudinal direction of the motorcycle 220 (i.e., along a common plane of the front wheel 224 and the rear wheel 228), passing through the center of the frame 222. The engine 232 provides power to drive the rear wheel 228 through a transmission 236 and an endless drive member 240. As illustrated, the engine 232 is a single-cylinder configuration having one cylinder 244 with a corresponding cylinder head 248 and valve cover 252. A throttle assembly 256 is mounted to the frame 222 and to the engine 232 and is configured to meter the flow of intake air into the engine 232. A header 257 and a muffler 258 are fluidly and mechanically coupled to the engine 232 and are configured to receive a flow of exhaust gases from the engine 232.

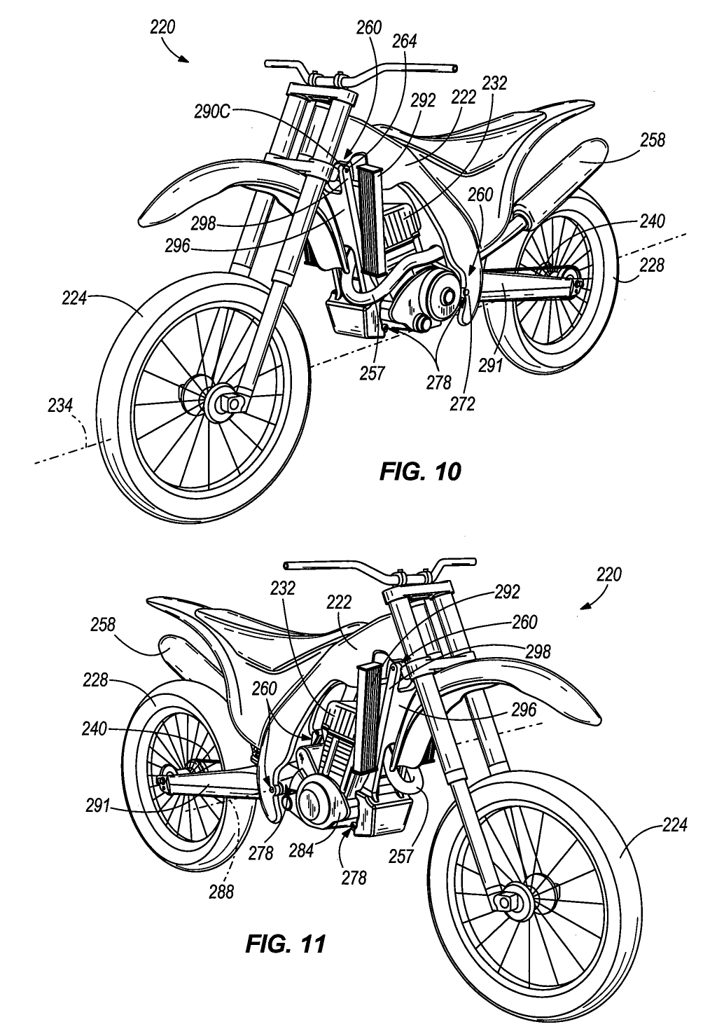

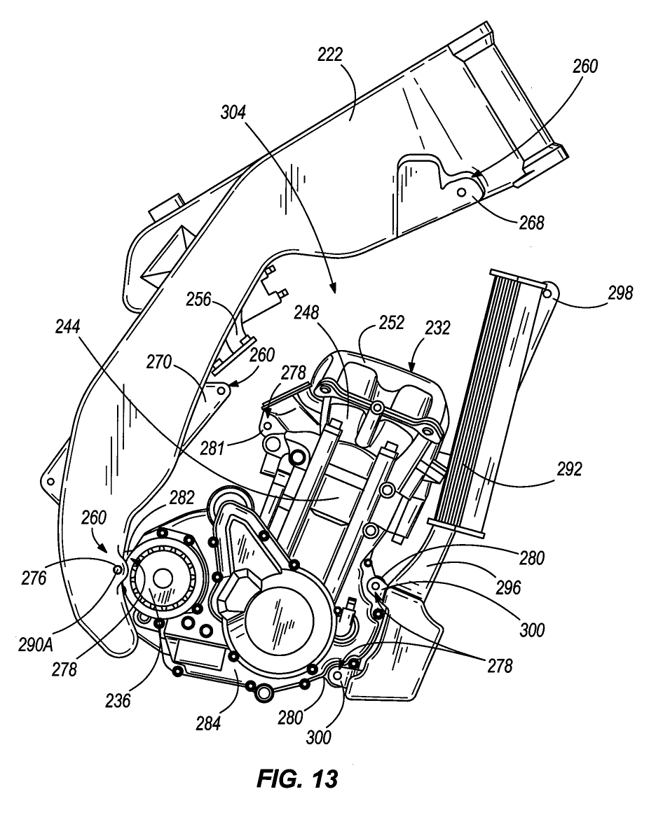

The frame 222 is provided with several mounting locations 260 including forward mounts 264, 268, a central mount 270, and rearward mounts 272, 276. Each of the mounts 264, 268, 270, 272, 276 includes a respective opening. The engine 232 is provided with several corresponding mounting locations 278 including forward mounts 280, a central mount 281, and rearward mounts 282 (FIG. 13). Each of the mounts 280, 281, 282 includes a respective opening. In some embodiments, the engine 232 is formed with a joint transmission case and crankcase 284, which is formed (e.g., integrally cast as a single piece) with the forward and rearward mounts 280, 282. The rearward mounts 282 define a mounting axis 288 (FIG. 11) substantially perpendicular to the central axis 234 of the motorcycle 220. A fastener 290A is configured to couple the frame 222 and the engine 232 at the mounting axis 288. A swingarm 291, which supports the rear wheel 228, is mounted by the fastener 290A at the mounting axis 288 and is configured to selectively pivot relative to the frame 222 and the engine 232 about the mounting axis 288. A fastener 290B is configured to couple the frame 222 and the engine 232 at the respective central mounts 270, 281.

The exemplary engine 232 is liquid cooled and is provided with a pair of radiators 292 positioned generally forward of the engine 232 and laterally adjacent the engine 232 on respective sides of the motorcycle 220. The radiators 292 are mounted to a mounting bracket 296, which is coupled to the frame 222 and to the engine 232. The radiators 292 are in fluid communication with cooling passages of the engine 232. Thus, the radiators 292 are fluidly and mechanically coupled to the engine 232. The mounting bracket 296 is generally H-shaped and includes a pair of mounting locations 298 configured to attach to the forward mounts 264, 268 of the frame 222. Fasteners 290C are configured to couple the frame 222 and the mounting bracket 296 where the forward mounts 264, 268 of the frame 222 meet the mounting locations 298 of the mounting bracket 296. Furthermore, the mounting bracket 296 includes four mounting locations 300 configured to attach to the forward mounts 280 of the engine 232. The engine 232, along with the radiators 292, the throttle assembly 256, the header 257, and the muffler 258 are part of an engine assembly 304.

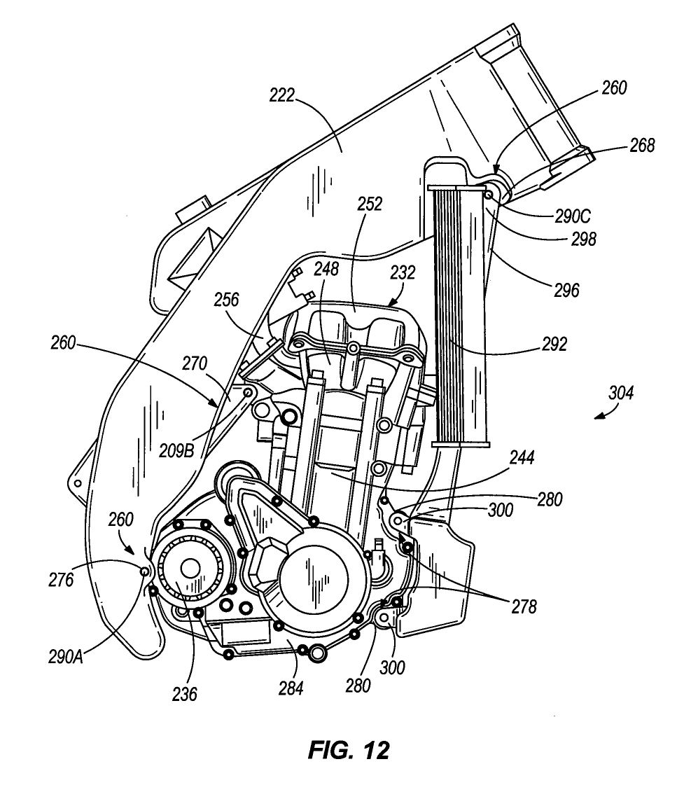

The frame 222 may be entirely cast as a single piece and does not include a frame portion either in front of or beneath the engine 232, such that the engine 232 is suspended from the frame 222. As described in further detail below, the engine 232 (along with selected components of the engine assembly 304) is movable in a generally forward and downward relative to the frame 222 about the mounting axis 288 between a first configuration or “mounted orientation” (FIG. 12) and a second configuration or “service orientation” (FIG. 13). In the service orientation, clearance above the engine 232 is increased compared to the mounted orientation. The increased clearance provided by the service orientation may enable service on the engine 232 that is very difficult or impossible to accomplish in the mounted orientation. Exemplary engine servicing procedures may include, but are not limited to, removal of the valve cover 252 of the engine 232, and checking/adjusting valve clearances within the cylinder head 248.

In order to move the engine 232 from the mounted orientation to the service orientation, the fasteners 290C are removed to detach the mounting bracket 296 from the forward mounts 264, 268 of the frame 222. When the mounting bracket 296 is detached from the frame 222, the radiators 292 remain fluidly and mechanically coupled directly to the engine 232. The throttle assembly 256 is disconnected from the engine 232 so that it remains fixed with the frame 222 along with the associated throttle cables and electrical wires. The fastener 290B is removed to detach the central mount 281 of the engine 232 from the central mount 270 of the frame 222 so that the engine 232 (along with the radiators 292, the header 257, and the muffler 258) is only supported by the frame 222 at the mounting axis 288. The fastener 290A at the mounting axis 288 is loosened, but not removed, to enable the engine 232 to rotate substantially freely about the mounting axis 288. The engine 232 is configured to rotate parallel to or along the central axis 234. The bottom part of the engine 232 and the transmission 236 rotate slightly rearward when the engine 232 is moved from the mounted orientation to the service orientation. Therefore, the endless drive member 240 does not require removal or adjustment of the associated final drive components.

After engine service has been completed, or when desired, the engine 232 is rotated back to the mounted orientation, and the central mount 281 of the engine 232 is re-attached to the central mount 270 of the frame 222. Likewise, the mounting bracket 296 is re-attached to the forward mounts 264, 268 of the frame 222. The fastener 290A at the mounting axis 288 is re-tightened, and the throttle assembly 256 is re-attached to the engine 232.

In some embodiments, rotation of the engine 232 about the mounting axis 288 of about 10 degrees is sufficient for creating an acceptable clearance to remove the valve cover 252, etc. However, the engine 232 may be rotated 15 degrees or more without breaking any “wet” connections of the radiators 292 because the radiators are fluidly and mechanically coupled directly to the engine 232.

Thus, the invention provides, among other things, a motorcycle engine rotatable for service, a motorcycle incorporating the same, and a method for configuring a motorcycle for service including rotating the engine relative to the frame from a mounted orientation to a service orientation. Various features and advantages of the invention are set forth in the claims.

What is claimed is:

1. A motorcycle comprising:
a frame including a first engine mount defining a first attachment axis, the frame further including a second engine mount spaced forwardly of the first engine mount;
an engine mounted to the frame at least by the first engine mount and the second engine mount, wherein the engine is configured to rotate relative to the frame about the first attachment axis when the engine is detached from the second engine mount; and
a radiator mounted to the engine, the radiator being fluidly coupled to the engine for heat transfer, wherein the radiator is configured to rotate with the engine relative to the frame about the first attachment axis.

2. The motorcycle of claim 1, wherein the radiator is selectively coupled to the frame, the radiator being configured to rotate with the engine when uncoupled from the frame.

3. The motorcycle of claim 1, further comprising a muffler associated with the engine, the muffler being coupled to the engine and configured to rotate relative to the frame about the first attachment axis along with the engine.

4. The motorcycle of claim 1, wherein the engine is suspended from the frame.

5. The motorcycle of claim 1, wherein the radiator is mounted laterally adjacent the engine.

6. An engine assembly configured to be coupled to a motorcycle frame, the engine assembly comprising:
an engine;
a cooling system including at least one liquid cooling component fluidly and mechanically coupled to the engine; and
a mounting arrangement configured to couple the engine to the motorcycle frame, wherein the mounting arrangement defines a mounting axis, the engine configured to be selectively rotatable about the mounting axis relative to the motorcycle frame with a connection between the liquid cooling component and the engine intact.

7. The engine assembly of claim 6, wherein the mounting arrangement includes a forward mounting location on the engine and a rearward mounting location on the engine, the mounting axis being defined by the rearward mounting location.

8. The engine assembly of claim 7, further comprising a central axis along a longitudinal direction of the motorcycle frame, wherein the engine is configured to rotate substantially along the longitudinal direction and about the mounting axis when the engine is uncoupled from the motorcycle frame at the forward mounting location.

9. The engine assembly of claim 6, further comprising a fuel supply line fluidly and mechanically coupled to the engine to supply liquid fuel to the engine, wherein the engine is configured to be selectively rotatable about the mounting axis relative to the motorcycle frame with a connection between the fuel supply line and the engine intact.

10. The engine assembly of claim 6, wherein the liquid cooling component includes at least one of a radiator and an oil cooler.

11. The engine assembly of claim 10, wherein the cooling system includes a pair of side-mounted radiators and a front-mounted oil cooler, both the pair of radiators and the oil cooler being mounted directly on the engine.

12. A method of servicing a cylinder head of an engine of a motorcycle, the method comprising:
providing a motorcycle frame, an engine, and a mounting arrangement therebetween, the engine being secured by the mounting arrangement in a mounted orientation relative to the frame;
disconnecting a portion of the mounting arrangement between the motorcycle frame and the engine so that the engine is only partially supported by the mounting arrangement; and
rotating the engine downward from the frame from the mounted orientation to a service orientation to increase the clearance between the cylinder head and the frame.

13. The method of claim 12, wherein disconnecting a portion of the mounting arrangement between the motorcycle frame and the engine includes removing two forwardly-positioned fasteners of the mounting arrangement.

14. The method of claim 12, further comprising moving the engine along a central axis of the motorcycle between the mounted and service orientations.

15. The method of claim 12, further comprising rotating a liquid cooling system with the engine from the mounted orientation to the service orientation.

16. The method of claim 12, further comprising performing an engine service procedure in the increased clearance between the cylinder head and the frame.

17. The method of claim 16, further comprising rotating the engine upward from the service orientation to the mounted orientation and re-connecting the disconnected portion of the mounting arrangement between the motorcycle frame and the engine so that the engine is fully supported by the mounting arrangement.

18. The method of claim 12, further comprising providing a radiator supported on the engine, wherein the radiator includes fluid connections to the engine.

19. The method of claim 18, wherein the engine is rotated from the mounted orientation to the service orientation with the fluid connections of the radiator intact.

20. The method of claim 18, wherein the radiator is supported on the engine at a first mounting location and is further supported on the frame at a second mounting location, the method further comprising detaching the radiator from the frame at the second mounting location so that the radiator is free to move with the engine relative to the frame.
